(19) United States
(12) Patent Application Publication
(10) Pub. No.: US 2004/0265462 A1
(43) Pub. Date: Dec. 30, 2004

(54) Nutritional supplement

(75) Inventor: Susan E. Carlson, Kansas City, MO (US)

Correspondence Address: STINSON MORRISON HECKER LLP, ATTN: PATENT GROUP, 1201 WALNUT STREET, SUITE 2800, KANSAS CITY, MO, 64106-2150, US

(73) Assignee: University of Kansas Medical Center

(21) Appl. No.: 10/874,852

(22) Filed: Jun. 23, 2004

Related U.S. Application Data
(60) Provisional application No. 60/480,922, filed on Jun. 24, 2003.

(51) Int. Cl. A23C 1/00

(52) U.S. Cl. 426/580

(57) ABSTRACT

A nutritional supplement comprising an infant milk formula having long chain poly unsaturated fatty acids, sialic acids, and cholesterol.

### CROSS-REFERENCE TO RELATED APPLICATIONS

This application claims priority to and is based on U.S. Provisional Application Ser. No. 60/480,922, filed on Jun. 24, 2003, which is hereby incorporated herein by reference.

### STATEMENT REGARDING FEDERALLY SPONSORED RESEARCH OR DEVELOPMENT

None.

### FIELD OF THE INVENTION

This invention relates to nutritional supplements and formulas, specifically enriched infant formulas that contain a source of long chain polyunsaturated fatty acids (“LC-PUFAs”), a source of sialic acid, and a source of cholesterol. Among other things, the compositions can be used to provide enhanced neurological development, gastrointestinal protection, and immune function in both term and preterm infants.

### DESCRIPTION OF RELATED ART

Human milk has long been recognized as the ideal feeding for term infants because of its nutritional composition and immunologic benefits. Human milk contains all of the nutrients required for the growth and development of the neonate. Three important components of human milk include LC-PUFAs, sialic acids, and cholesterol. See generally Jensen, Handbook of Milk Composition (Academic Press 1995).

Human milk contains on average about 50% of energy from fat. This equates to about 67 kcal/dl or about 3.7 g/dl of fat. The majority of fat consists of fatty acids in various glycerides, phospholipids, cholesterol esters, and complex lipids. Typically oleic acid accounts for about 30 to 35 wt % of total fatty acids. Typically, about 15-19% of fatty acids are LC-PUFAs. See Putnam et al., The effect of variations in dietary fatty acids on the fatty acid composition of erythrocyte phosphatidylcholine and phosphatidylethanolamine in human infants, Am J Clin Nutr 1982;36:106-114. Of these, the docosahexaenoic acid and arachidonic acid content ranges from about 0.05% to 2.8 wt % and about 0.3 to 1.0 wt % of total fatty acids, respectively, and decreases post-partum. Worldwide, the mean is about 0.35 wt % (12 mg/dl) and 0.6% (21 mg/dl) for docosahexaenoic acid and arachidonic acid, respectively. See generally Jensen, Handbook of Milk Composition, at Table XI, pp. 509-510 (Academic Press 1995); Tomarelli, Suitable fatformulations for infant feeding in Dietary Fat Requirements in Health and Development, (J. Beare-Rodgers ed.), American Oil Chemists Society; Harzer et al., Changing patterns of human milk lipids in the course of the lactation and during the day, Am J Clin Nutr April 1983; 37(4):612-21; Boersma et al., Vitamin E, lipid fractions, and fatty acid composition of colostrum, transitional milk, and mature milk: an international comparative study, Am J Clin Nutr May 1991; 53(5):1197-204.

In human milk, sialic acid is present in different sialoglycoconjugate compounds such as oligosaccharides, glycolipids and glycoproteins, not in a free form. Human milk contains about 0.3-1.5 mg/ml of sialic acid. Sialic acid bound to oligosaccharides accounts for about 75% of the total sialic acid contained in human milk—or about 200 to 1800 mg/L. Most of the sialic acid contained in human milk is found in the form of sialyllactose, an oligosaccharide formed from lactose and sialic acid. The amount of sialic acid in glycoproteins of milk ranges from about 100 to 500 mg/L, declining to about 70 mg/L by 12 weeks of lactation. See Carlson, N-acetylneuraminic acid concentrations in human milk oligosaccharides and glycoproteins during lactation, Am J Clin Nutr. April 1985; 41(4):720-6. In milk, gangliosides, which are sialic acid-containing glycolipid, occur mainly as monosialoganglioside 3 (GM3) and disialoganglioside 3 (GD3). The concentration of GM3 in human milk increases, while that of GD3 concentration decreases during lactation. Gangliosides account for about 1% or less of sialic acid in human milk, and decreases substantially within the first few months of lactation. See Nakano et al., Sialic acid in human milk: composition and functions, Acta Paediatr Taiwan January-February 2001; 42(1): 11-7.

Human milk also contains 10-20 mg/dl of sterols, and the majority of that comprises cholesterol. See Jensen, Lipids in human milk—Composition and fat soluble vitamins, in Textbook of Gastroenterology in Infancy (Lebenthal el., 2d ed), pp. 57-208; Kallio et al., Cholesterol and its precursors in human milk during prolonged exclusive breast-feeding, Am J Clin Nutr October 1989; 50(4):782-5. One study reported a mean cholesterol content of 36.0 mg/dl between 0 and 4 days post-partum, 19.7 mg/dl between days 5 and 9, and 19.0 mg/dl between days 10 and 30. See Boersma et al., Vitamin E, lipid fractions, and fatty acid composition of colostrum, transitional milk, and mature milk: an international comparative study, Am J Clin Nutr May 1991; 53(5):1197-204.

LC-PUFAs, sialic acid, and cholesterol have been incorporated to some extent in infant milk formulas. See generally Jensen, Handbook of Milk Composition (Academic Press 1995), at pp. 835-855. Applicant is a co-inventor of U.S. Pat. No. 6,306,908, which illustrates that LC-PUFAs are useful in reducing necrotizing enterocolitis. Nevertheless, whether or not formulas designed for the preterm infant should be supplemented with LC-PUFAs, including arachidonic acid (“AA”, 20:4n-6) and/or docosahexaenoic acid (“DHA”, 22:6n-3) has become one of the most controversial issues in infant nutrition today. See generally Carlson, U.S. Pat. No. 6,306,908.

Studies have also shown that low levels of sialic acids are incorporated to into infant formula. See Carlson, N-acetylneuraminic acid concentrations in human milk oligosaccharides and glycoproteins during lactation, Am J Clin Nutr. April 1985; 41(4):720-6; Martin-Sosa et al., Sialyloligosaccharides in human and bovine milk and in infant formulas: variations with the progression of lactation, J Dairy Sci January 2003; 86(1):52-9 (finding that infant formulas did not contain significant amounts of sialyloligosaccharides); Wang et al., Concentration and distribution of sialic acid in human milk and infant formulas, Am J Clin Nutr October 2001; 74(4):510-5 (finding that the sialic acid content of most formulas was <25% of that found in mature human milk); Pan X L & Izumi, Variation of the ganglioside compositions of human milk, cow's milk and infant formulas, Early Hum Dev January 2000; 57(1):25-31 (finding that the major ganglioside in the later human milk, GM3 (27.7%), was only a minor component in the colostrum, cow's milk and infant formulas (3.3, 2.8 and 0.4-2.6%, respectively)). Researchers have theorized that supplementation with sialic acid-containing glycoconjugates of infant formulas would be recommended for the first days after delivery when breast-feeding is not possible. The theory was that the reference standard for optimal nutrition in the early months of infancy is human milk. See Carlson, Human milk nonprotein nitrogen: occurrence and possible functions, Adv Pediatr. 1985;32:43-70; Sanchez-Diaz, A critical analysis of total sialic acid and sialoglycoconjugate contents of bovine milk-based infant formulas, J Pediatr Gastroenterol Nutr April 1997; 24(4):405-10. However, to the inventor's knowledge, no such products have ever been produced which contain such amounts of sialic acids.

Cholesterol is usually incorporated into infant formulas in minor amounts. For example, one study reported that formulas had cholesterol concentrations 3 to 35 times lower than human milk. See Huisman et al., Triglycerides, fatty acids, sterols, mono- and disaccharides and sugar alcohols in human milk and current types of infant formula milk. Eur J Clin Nutr April 1996; 50(4):255-60. Prior work by the inventor has shown that infants fed human milk have significantly higher total plasma cholesterol than infants fed formula and higher combined low-density and very-low-density lipoprotein (“LDL-VLDL”) levels. See Carlson et al., Effect of infant diets with different polyunsaturated to saturated fat ratios on circulating high-density lipoproteins, J Pediatr Gastroenterol Nutr. 1982;1(3):303-9. U.S. Pat. No. 4,303,692 to Gaull teaches an infant formulation containing cholesterol in the range from 20% less to 20% more than the cholesterol concentration found in human milk.

Although human milk contains LC-PUFAs, sialic acid, and cholesterol, no infant formula has incorporated the combination of these materials into a single formulation in amounts at or near those of human milk. The present invention is directed to a nutritional supplement which includes LC-PUFAs, and in particular AA and DHA, sialic acid, cholesterol in such a manner.

### BRIEF SUMMARY OF THE INVENTION

It is another object of the present invention to provide a nutritional supplement.

It is a further object of the present invention to provide an infant formula which contains LC-PUFAs, sialic acid, and cholesterol in amounts that are within the ranges of human milk.

### DETAILED DESCRIPTION OF PREFERRED EMBODIMENT

The present invention relates to an “infant formula.” Those skilled in the art will readily understand what is meant by an infant formula. When diluted or reconstituted, if initially in concentrate or powder form, to the ready to feed state, a typical infant formula contains about 10-35 g/L of protein; 20-50 g/L of lipid; 60-110 g/L of carbohydrates and other various components such as vitamins, minerals, fibers, emulsifiers and the like. The term “infant formula” includes so-called “pre-term” and “term” formulas well known to those skilled in the art. For purposes of understanding the components of an infant formula and methods for its production, the following U.S. patents are herein incorporated by reference: (1) U.S. Pat. No. 6,146,670 to Prieto et al. (2) U.S. Pat. No. 6,080,787 to Carlson; (3) U.S. Pat. No. 5,492,899 to Masor et al.; (4) U.S. Pat. No. 5,021,245 to Borschel et al.; (5) U.S. Pat. No. 5,234,702 to Katz et al.; (6) U.S. Pat. No. 5,602,109 to Masor et al.; (7) U.S. Pat. No. 5,492,938 to Kyle et al.; (8) U.S. Pat. No. 4,670,268 to Mahmoud; (9) U.S. Pat. No. 4,670,285 to Clandinin et al.; (10) U.S. Pat. No. 4,303,692 to Gaull; (11) U.S. Pat. No. 4,216,236 to Mueller et al; (12) U.S. Pat. No. 3,798,339 to Peng, (13) U.S. Pat. No. 3,542,560 to Tomarelli et al.; and (14) U.S. Pat. No. 2,694,640 to Gyorgy. Exemplary infant formulas which are commercially available include ENFAMIL, PROSOBEE, PREGESTIMIL, PORTAGEN, NUTRAMIGEN, LOFENALAC, LACTOFREE, GERBER, ALACTA, O-LAC, PROLOSAC (Mead Johnson & Company, Evansville, Ind.), SIMILAC, ISOMIL (Ross Laboratories, Columbus, Ohio), SMA, NURSOY, WYSOY, INFASOY, BONNA MAYORCITOS, STARMIL, (Wyeth Laboratories, Philadelphia, Pa.), ALPREM, SOYALAC, FOLLOW-UP, GOODSTART (Nestle Carnation), NENATAL, PREMATALAC, AMMIRON, NUTRILON, NUTRI-SOJA, FARILON, COW & GATE, CAMELPOW, NENATAL, PEPTI-JR (Nutricia/Cow & Gate, Netherlands), and PREAPTAMIL, APTAMIL, MILUMIL, LEMIEL, NEKTARMIL, HN-25, GES-45, SOM, PREGOMIN (Milupa, Germany).

The synthetic infant formula of the present invention includes a source of LC-PUFAs, source of sialic acid, and source of cholesterol. Each of these three components is preferably contained in the infant formula in amounts corresponding to that of natural human milk.

A. Long Chain Poly-Unsaturated Fatty Acid Source

Fatty acids are carboxylic acids and are classified based on the length and saturation characteristics of the carbon chain. Short chain fatty acids have 2 to about 6 carbons and are typically saturated. Medium chain fatty acids have from about 6 to about 14 carbons and are also typically saturated. Long chain fatty acids have from 16 to 24 or more carbons and may also be saturated or unsaturated. In longer fatty acids there may be one or more points of unsaturation, giving rise to the terms “monounsaturated” and “polyunsaturated”, respectively.

As used herein, the term “long chain polyunsaturated acid” (LC-PUFA) means a fatty acid of twenty carbon atoms or more having at least two carbon-carbon double bonds (polyunsaturated). The number and position of double bonds in fatty acids are designated by a convention of nomenclature. For example, arachidonic acid (“AA” or “ARA”) has a chain length of 20 carbons and 4 double bonds beginning at the sixth carbon. As a result, it is referred to as “20:4 n-6”. Similarly, docosahexaenoic acid (“DHA”) has a chain length of 22 carbons with 6 double bonds beginning with the third carbon from the methyl end and is thus designated “22:6 n-3”.

Other important LC-PUFAs are the fatty acids that are precursors in these biosynthetic pathways of AA and DHA, for example, linoleic (18:2 n-6), γ-linolenic (18:3 n-6), and dihomo-γ-linolenic (20:3 n-6) acids in the n-6 pathway, and α-linolenic (18:3 n-3), stearidonic (18:4 n-3), eicosatetraenoic (20:4 n-3), eicosapentaenoic (20:5 n-3), and docosapentaenoic (22:6 n-3) in the n-3 pathway. Less prevalent LC-PUFAs are known and listed in Tables I and IV of Carlson et al., U.S. Pat. No. 6,080,787 and Table XI of Jensen (pp. 509), which are incorporated by reference. The most preferred LC-PUFAs are the 20 and 22 carbon metabolites, and in particular AA and DHA.

Fatty acids are often found in nature as acyl radicals esterified to alcohols. A glyceride is such an ester of one or more fatty acids with glycerol (1,2,3-propanetriol). If only one position of the glycerol backbone molecule is esterified with a fatty acid, a “monoglyceride” is produced; if two positions are esterified, a “diglyceride” is produced; and if all three positions of the glycerol are esterified with fatty acid a “triglyceride” or “triacylglycerol” is produced. A glyceride is called “simple” if all esterified positions contain the same fatty acid; or “mixed” if different fatty acids are involved.

A phospholipid (also called a “phosphoglyceride” or “phosphatide”) is a special type of glyceride. A phosphoglyceride differs from a triglyceride in having a maximum of two esterified fatty acids, while the third position of the glycerol backbone is esterified to phosphoric acid, becoming a “phosphatidic acid”. In nature, phosphatidic acid is usually associated with an alcohol which contributes a strongly polar head. Two such alcohols commonly found in nature are choline and enthanolamine. A “lecithin” is a phosphatidic acid associated with the aminoalcohol, “choline”, and is also known as “phosphatidylcholine”. Lecithins vary in the content of the fatty acid component and can be sourced from, for example, eggs and soy. Cephalin (phosphatidylethanolamine), phosphatidylserine and phosphatidylinositol are other phosphoglycerides.

Triglycerides and phospholipids are often classified as long chain or medium chain, according to the fatty acids attached thereto. In human milk, about 98% of the fatty acids are in triglycerides. A source of fatty acids may include any of these forms of glycerides from natural or other origins. Sources of LC-PUFAs include dairy products like eggs and butterfat; marine oils, such as cod, menhaden, sardine, tuna and many other fish; certain animal fats, lard, tallow and microbial oils such as fungal and algal oils as described in detail in U.S. Pat. Nos. 5,374,657, 5,550,156, and 5,658,767. Notably, fish oils are a good source of DHA and they are commercially available in “high EPA” and “low EPA” varieties, the latter having a high DHA:EPA ratio, preferably at least 3:1. Algal oils such as those from dinoflagellates of the class Dinophyceae, notably Crypthecodinium cohnii are also sources of DHA (including DHASCO.™.), as taught in U.S. Pat. Nos. 5,397,591, 5,407,957, 5,492,938, and 5,711,983. The genus Mortierella, especially M. alpina, and Pythium insidiosum are good sources of AA, including ARASCO as taught by U.S. Pat. No. 5,658,767 and as taught by Yamada, et al. J. Dispersion Science and Technology, 10(4&5), pp. 561-579 (1989), and Shirunen, et al. Appl. Microbiol. Biotechnol. 31:11-16 (1989).

Of course, new sources of LC-PUFAs may be developed through the genetic manipulation of other organisms, particularly vegetables and/or oil bearing plants. Desaturase and elongase genes have been identified from many organisms and these might be engineered into plant or other host cells to cause them to produce large quantities of LC-PUFA-containing oils at low cost. The use of such recombinant oils are also contemplated in the present invention.

The LC-PUFAs may be provided in the composition in the form of esters of free fatty acids; mono-, di- and tri-glycerides; phosphoglycerides, including lecithins; and/or mixtures thereof. It may be preferable to provide LC-PUFAs in the form of phospholipids, especially phosphatidylcholine. A presently preferred source, at least when processed such that the organoleptic properties and cholesterol level are acceptable, appears to be egg yolk phospholipids, perhaps due to the high phospholipid and/or phosphatidylcholine content associated with egg derived LC-PUFAs.

The infant formula of the present invention includes a source of LC-PUFAs that are within the range of human milk. The LC-PUFAs preferably comprise between about 4.5 to 15% by weight of total fatty acids, and comprise about 35 to 560 mg/dL.

Even more preferably, the amount of LC-PUFAs in the n-6 pathway and the and n-3 pathway are within the range of human milk. The amount of LC-PUFAs in the n-6 pathway preferably range from about 10-15 wt % total fatty acids. In addition, the LC-PUFAs in the n-6 pathway preferably contain less than about 10-15% linoleic acid (18:2n-3) of total fatty acids, and even more preferably between about 10-12 wt %. The formula preferably contains about 150 to 450 mg/dl of LC-PUFAs in the n-6 pathway and about 20 to 80 mg/dl of LC-PUFAs in the n-3 pathway.

The 20 and 22 carbon metabolites in the n-6 pathway preferably comprise of total fatty acids. The amount of LC-PUFAs in the n-3 pathway preferably range from about 0.35 to 1.5% wt % total fatty acids. The 20 and 22 carbon metabolites in the n-3 pathway preferably comprise about 0.5 to 1% of total fatty acids.

The n-6 and/or n-3 LC-PUFAs may be administered in the form of an intravenous (i.e. parenteral) solution, as can choline and phosphatidylcholine. An intravenous solution will preferably contain effective amounts of the LC-PUFA, the phospholipid and/or the choline in a reasonable daily intake of parenteral solution. The exact concentration, therefore, is highly variable depending on the anticipated intake volume and is significantly more concentrated in a bolus or small-volume parenteral than in a hydrating or nutritional based parenteral product. Parenteral compositions will generally include pharmaceutically acceptable vehicles and excipients, such as buffers, preservatives, and the like.

The n-6 and/or n-3 LC-PUFAs and the choline and phospholipid may alternatively be administered in the form of an enteral composition. Enteral compositions containing the long chain PUFA, choline or phospholipid may be in the form of a solution or an emulsion of active ingredient; or in a nutritional matrix comprising protein, carbohydrates, other fats, minerals and vitamins. Enteral compositions containing active components may provide either supplemental or complete nutritional support. The concentration of the LC-PUFAs in the enteral composition can range from about 0.35 to 4.0% of AA and DHA depending on the mode of administration and intended purpose. In complete nutritional formulas the concentration may be even lower if enough of the formula is administered to deliver effective amounts of the LC-PUFA. The infant formula preferably provides about 35 to 75% of its energy, and more preferably about 45 to 55% of its energy in the form of fatty acids.

More preferably, the invention present comprehends an infant formula containing about 40-50 gms of lipid per liter of formula wherein the lipid comprises a blend of medium chain triglycerides and egg phospholipid. Typically, the lipid blend comprises from about 1-40 wt. %, more preferably about 5 to about 30 wt. %, of the egg phospholipid. This embodiment is specifically designed to provide LC-PUFAs selected from n-3 fatty acids and n-6 fatty acids, phospholipids, and/or choline in amounts beneficial to infants.

In the most preferred embodiment, the infant formula contains amounts of AA and DHA that is with in the range of human milk.

Preferably, the DHA content of the infant formula of the present invention ranges between about 0.05% to about 2.8 wt % of the total fatty acids. Even more preferably, DHA content is between 0.15 and 1.5 wt % of the total fatty acids. Still more preferably, the DHA content ranges between about 0.35 to 1.2 wt % of the total fatty acids.

Preferably, the infant formula of the present invention contains about 2 to 104 mg/dL of DHA, even more preferably, about 6 to 60 mg/dL of DHA, and still more preferably about 13 to 45 mg/dL of DHA.

Preferably, the AA content of the infant formula of the present invention ranges between about 0.3% to about 1.2 wt % of the total fatty acids. Even more preferably, AA content is between 0.4 and 1.0 wt % of the total fatty acids. Still more preferably, the AA content ranges between about 0.5 to 0.8 wt % of the total fatty acids.

Preferably, the infant formula of the present invention contains about 11 to 44 mg/dL of AA, even more preferably, about 15 to 35 mg/dL of AA, and still more preferably about 23 to 30 mg/dL of AA.

In the preferred embodiment, the fatty acid composition of the infant formula mimics that of human milk. More specifically, the formula preferably includes about 30 to 50% of the fatty acids as monounsaturated acids. Even more preferably, the formula contains about 30 to 40% of the fatty acids as oleic acid (18:n-9). Research has suggested that the prolonged feeding of a diet enriched in polyunsaturated acids in early infancy has a significant cholesterol-lowering effect compared to monounsaturates. More specifically, infants fed formula with higher amounts of linoleic acid (18:2 n-6) have lower cholesterol than those fed formulas high in oleic acid. See Carlson et al., Effect of infant diets with different polyunsaturated to saturated fat ratios on circulating high-density lipoproteins, J Pediatr Gastroenterol Nutr. 1982;1(3):303-9; Mize et al., Lipoprotein-cholesterol responses in healthy infants fed defined diets from ages 1 to 12 months: comparison of diets predominant in oleic acid versus linoleic acid, with parallel observations in infants fed a human milk-based diet, J Lipid Res. June 1995; 36(6):1178-87. Further, if the infants are preterm, they develop large amounts of an unusual fatty acid in their red blood cell membrane sphingomyelin. See Peeples et al., Effect of LCPUFAS and age on red blood cell sphingomyelin 24:1n-9 and 24:2 of preterm infants with reference to term infants, PUFA in Infant Nutrition: Consensus and Controversies, Barcelona Spain, Program Abstracts, 1996, p. 3); Putnam et al., The effect of variations in dietary fatty acids on the fatty acid composition of erythrocyte phosphatidylcholine and phosphatidylethanolamine in human infants, Am J Clin Nutr 1982;36:106-114. Thus, the present invention preferably includes a suitable balance of monounsaturated/polyunsaturated fats so that the cholesterol is not undesirably lowered.

B. Sialic Acid Source

The term “sialic acid” (abbreviated “Sia”) refers to any member of a family of nine-carbon carboxylated sugars. The most common member of the sialic acid family is N-acetyl-neuraminic acid (2-keto-5-acetamindo-3,5-dideoxy-D-glycero-D-galactononulopyranos-1-onic acid (often abbreviated as Neu5Ac, NeuAc, or NANA). A second member of the family is N-glycolyl-neuraminic acid (Neu5Gc or NeuGc), in which the N-acetyl group of NeuAc is hydroxylated. A third sialic acid family member is 2-keto-3-deoxy-nonulosonic acid (KDN) (Nadano et al. (1986) J. Biol. Chem. 261: 11550-11557; Kanamori et al. (1990) J. Biol. Chem. 265: 21811-21819. Also included are 9-substituted sialic acids such as a 9-O—C₁-C₆ acyl-Neu5Ac like 9-O-lactyl-Neu5Ac or 9-O-acetyl-Neu5Ac, 9-deoxy-9-fluoro-Neu5Ac and 9-azido-9-deoxy-Neu5Ac. For review of the sialic acid family, see, e.g., Varki (1992) Glycobiology 2: 25-40; Sialic Acids: Chemistry, Metabolism and Function, R. Schauer, Ed. (Springer-Verlag, New York (1992). The synthesis and use of sialic acid compounds in a sialylation procedure is described in, for example, international application WO 92/16640, published Oct. 1, 1992.

Based on the foregoing, those skilled in the art will appreciate that sources of sialic acid include, but are not limited to free sialic acid (such as NANA), as well as sialic acid (such as NANA) complexed to oligosaccharides, glycoproteins, and gangliosides.

In the preferred infant formula, the sources of sialic acid are comprised predominantly of NANA sources as opposed to other sialic acids, such as Neu5Gc. Even more preferably, NANA sources are exclusively used. Humans are the only mammalian species that do not convert NANA to NeuGc. As such, the present invention contemplates that that NANA-containing sources are most preferred.

Oligosaccharides are polymers of varying number of residues, linkages, and subunits. The basic subunit is a carbohydrate monosaccharide or sugar, such as mannose, glucose, galactose, N-acetylglucosamine, N-acetylgalactosamine, and the like. The number of different possible stereoisomeric oligosaccharide chains is enormous. It has been estimated that more than 130 separate neutral and acidic compounds with from 3 to 22 sugars/molecules have been identified in human milk. The sialyated oligosaccharides of the present invention preferably include one or more of the sialic acid containing oligosaccharides listed in Table VI of Jensen, Handbook of Milk Composition (Academic Press 1995), at pp. 293-300, which is hereby incorporated by reference. The present invention can utilize sialic acid any form with sugar moieties, either naturally found or artificially formulated from simple to complex. The simplest is sialylglucose. See Carlson, Human milk nonprotein nitrogen: occurrence and possible functions, Adv Pediatr. 1985;32:43-70. Sialyllactose, which is commercially available from (MoBiTech, Germany), is most preferred.

Natural sources of sialydated glycoproteins are well known to those skilled in the art based on of the functional roles of the glycoproteins themselves, e.g., bile salt-stimulated lipase (BSSL), erythropoietin (EPO) and lactoferrin as well as immunoglobulins. These biological glycoproteins are not good sources of NANA, but the sialic acid could be added to a protein source.

Gangliosides are a class of glycolipids, often found in cell membranes, that consist of three elements. One or more sialic acid residues are attached to an oligosaccharide or carbohydrate core moiety, which in turn is attached to a hydrophobic lipid (ceramide) structure which generally is embedded in the cell membrane. The ceramide moiety includes a long chain base (LCB) portion and a fatty acid (FA) portion. Gangliosides, as well as other glycolipids and their structures in general, are discussed in, for example, Lehninger, Biochemistry (Worth Publishers, 1981) pp. 287-295 and Devlin, Textbook of Biochemistry (Wiley-Liss, 1992). Gangliosides are classified according to the number of monosaccharides in the carbohydrate moiety, as well as the number and location of sialic acid groups present in the carbohydrate moiety. Monosialogangliosides are given the designation “GM”, disialogangliosides are designated “GD”, trisialogangliosides “GT”, and tetrasialogangliosides are designated “GQ”. Gangliosides can be classified further depending on the position or positions of the sialic acid residue or residues bound. Further classification is based on the number of saccharides present in the oligosaccharide core, with the subscript “1” designating a ganglioside that has four saccharide residues (Gal-GalNAc-Gal-Glc-Ceramide), and the subscripts “2”, “3” and “4” representing trisaccharide (GalNAc-Gal-Glc-Ceramide), disaccharide (Gal-Glc-Ceramide) and monosaccharide (Gal-Ceramide) gangliosides, respectively. GM3, GD3, and GM1 are the most preferred gangliosides of the present invention. Sources of gangliosides include deer velvet (actively growing cartilage type tissue in premature deer antlers) and gangliosides isolated from brain (mostly bovine, but theoretically any animal brain could be a source). Gangliosides are commercially available from Larodan Lipids (Sweden). Those skilled in the art will appreciate that gangliosides may also be biosynthesized.

The infant formula of the present invention includes a source of sialic acid that is within the range of human milk. More specifically, the infant formula preferably comprises about 200-2300 mg/L of sialic acid, even more preferably about 400 to 700 mg/L of sialic acid and most preferably about 500 to 600 mg/L sialic acid.

The infant formula of the present invention preferably includes sialic acids complexed with oligosaccharides. The oligosaccharide-bound sialic acids preferably comprise between about 50 and 100% of the total source of sialic acids. Even more preferably, the sialic acid complexed with oligosaccharides account for about 70 to 80% of the sialic acid in the formula. The oligosaccharide-bound sialic acids preferably range between about 200 and 1800 mg/L, even more preferably about 400 to 1200 mg/L, and still most preferably about 500 to 600 mg/L.

The infant formula of the present invention preferably includes sialic acids complexed with glycoproteins. The glycoprotein-bound sialic acids preferably comprise between about 10% and 50% of the total source of sialic acids. Even more preferably, the sialic acid complexed with glycoproteins account for about 20 to 30% of the sialic acid in the formula. The glycoprotein-bound sialic acid preferably ranges between about 100 to 550 mg/L, and still more preferably between about 200 to 300 mg/L.

The infant formula of the present invention preferably ganglioside-bound sialic acids. The gangliosides preferably comprises between about 0% and 5% of the total source of sialic acids. Even more preferably, the gangliosides account for less than 1% of the sialic acid in the formula. The formula preferably contains less than 5 mg/L gangliosides.

C. Cholesterol Source

The present invention also includes a source of cholesterol well known to those skilled in the art. Among other things, cholesterol is found in eggs, beef tallow, dairy products, meat, poultry, fish, and shellfish. Egg yolks and organ meats (liver, kidney, sweetbread, and brain) are high in dietary cholesterol. Fish generally contains less cholesterol than other meats, but some shellfish is high in cholesterol content. Sources of cholesterol also include precursors such as squalene, lanosterol, dimethylsterol, methostenol, lathosterol, and desmosterol.

The infant formula of the present invention comprises about 10 to 40 mg/dl cholesterol. Even more preferably, the present invention comprises about 15 to 26 mg/dl cholesterol.

The synthetic infant formula of the present invention may be made de novo using methods well known to those skilled in the art. Alternatively, the infant formula may be made by modifying an existing infant formula to contain LC-PUFAs, sialic acids, and cholesterol within the range of human milk.

### EXAMPLES

### Prophetic Example 1

Egg yolk cholesterol, N-acetylneuraminic acid, docosahexaenoic acid and arachidonic acid obtained from commercial sources are used in the following Examples. Those skilled in the art will appreciate that procedures for isolating cholesterol and N-acetylneuraminic acid from traditional food sources exist (for example from egg yolk and mammalian milk, respectively) and could be modified to produce these components in the quantities necessary for bulk addition to infant formula as specified herein. Docosahexaenoic acid and arachidonic acid from fish, egg yolk lipids, egg yolk phospholipids and single cell oil sources are commercially available from a number of sources and are well known to those skilled in the art.

In this example, egg yolk cholesterol and N-acetylneuraminic acid would be added to a cows-milk-derived formula that is currently marketed and that contains at least 0.35% docosahexaenoic acid (Martek Biosciences) and 0.5% arachidonic acid (Martek Biosciences) of total fatty acids from single cell oil sources. Cholesterol would comprise 200 mg/L of formula. N-acetylneuraminic acid would be added in amounts of 500 mg/L as the free sugar. Both compounds could be added in these amounts without a need to change any other component of the currently marketed formula.

Those skilled in the art will know that the marketed formula will needed to include macronutrients and other components within preferred ranges. See e.g., Table II of U.S. Pat. No. 6,306,908, which is incorporated by reference.

### Prophetic Example 2

In this example, egg yolk lipid is added with N-acetylneuraminic acid to a currently marketed formula with docosahexaenoic acid from the sources and amounts in Example 1. The egg yolk lipid would provide 200 mg/L of cholesterol and some arachidonic acid. A single cell source of arachidonic acid is added to achieve 0.5% of total fatty acids as arachidonic acid.

### Prophetic Example 3

In this example, cholesterol isolated from egg yolk and siallylactose from cows' milk would be added to a currently marketed formula that contains docosahexaenoic acid and arachidonic acid as 0.35 and 0.5% of total fatty acids, respectively. Cholesterol would contribute 200 mg/L formula and siallylactose would contribute 500 mg sialic acid/L. Lactose in the formula is decreased in the amount of lactose added via siallylactose per liter.

As discussed above, human milk contains cholesterol, LC-PUFAs, and sialic acid. All three of these components are found in the plasma membranes of cells. In particular all three compounds are present in regions of the membrane known as lipid rafts. These lipid rafts are operationally defined as regions of the plasma membrane that are not soluble in detergent. These microdomains on the plasma membrane are rich in cholesterol (˜50%), sphingolipids, including some gangliosides(˜10-20%) and phospholipids. A variety of proteins are enriched in lipid rafts. These include caveolins, flotilins, GPI-linked proteins, low molecular weight and heterotrimeric G proteins, src family kinases, EGF receptors,, platelet-derived growth factor (PDGF) receptors, endothelin receptors, MAP kinase, protein kinase C etc. A variety of mechanisms appear to be employed for localizing proteins to lipid rafts (Pike, J. Lipid Res. 2003;44:655-667).

Changes in these lipid rafts likely have both long-term and short-term consequences for the developing organism. These components likely influence the cell function, especially involving neutotransmitters, proteins involved in signal transduction, and proteins that function as enzymes in catalyzing the metabolic reactions. For example, the present invention contemplates that all three components are thought to be important for signaling between cells of different types, such as myelination of neurons by oligodendrocytes. In addition to development of the central nervous system, the present invention therefore predicts that alteration in LC-PUFAs, cholesterol in sialic acid can affect membranes in any organ or cell of the body and therefore function. For example changes in renal brush-border membrane cholesterol can suppress or promote domains.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

What is claimed and desired to be secured by Letters Patent is as follows:

1. A synthetic infant milk formula comprising:
about 35 to 560 mg/dL long-chain poly unsaturated fatty acids (“LC-PUFAs”);
about 200 to 2300 mg/L sialic acids; and
about 10 to 40 mg/dl of cholesterol.

2. The synthetic infant milk formula of claim 1 wherein said LC-PUFAs comprises one or more fatty acids in the n-6 pathway.

3. The synthetic infant milk formula of claim 2 wherein said LC-PUFAs comprises at least one fatty acid selected from the group consisting of γ-linolenic (18:3 n-6), and dihomo-γ-linolenic (20:3 n-6) acids.

4. The synthetic infant milk formula of claim 1 wherein said LC-PUFAs comprise about 150 to 450 mg/dl of n-6 LC-PUFAs.

5. The synthetic infant milk formula of claim 1 wherein LC-PUFAs comprises one or more fatty acids in the n-3 pathway.

6. The synthetic infant milk formula of claim 4 wherein said LC-PUFAs comprises at least one fatty acid selected from the group consisting of α-linolenic (18:3 n-3), stearidonic (18:4 n-3), eicosatetraenoic (20:4 n-3), eicosapentaenoic (20:5 n-3), and docosapentaenoic (22:6 n-3) acids.

7. The synthetic infant milk formula of claim 1 wherein said LC-PUFAs comprise about 20 to 80 mg/dl of n-3 LC-PUFAs.

8. The synthetic infant milk formula of claim 1 wherein said formula comprises DHA in an amount of about 0.05 to 2.8 wt % of total fatty acids.

9. The synthetic infant milk formula of claim 1 wherein said formula comprises DHA in an amount of about 0.35 to 1.2 wt % of total fatty acids.

10. The synthetic infant milk formula of claim 1 wherein said formula comprises AA in an amount of about 0.3 to 1.2 wt % of total fatty acids.

11. The synthetic infant milk formula of claim 1 wherein said formula comprises AA in an amount of about 0.5 to 0.8 wt % of total fatty acids.

12. The synthetic infant milk formula of claim 1 wherein said formula comprises DHA in an amount of about 0.35 to 1.2 wt % of the total fatty acids and AA in an amount of about 0.5 to 0.8 wt % of the total fatty acids.

13. The synthetic infant milk formula of claim 1 wherein said formula comprises 6 to 60 mg/dL of DHA.

14. The synthetic infant milk formula of claim 13 further comprising about 15 to 35 mg/dL of AA.

15. The synthetic infant milk formula of claim 1 wherein said LC-PUFAs preferably contain less than about 11 wt % of linoleic acid (18:2n-3) of total fatty acids.

16. The synthetic infant milk formula of claim 1 wherein said LC-PUFAs comprises egg phospholipid.

17. The synthetic infant milk formula of claim 1 wherein said sialic acids are selected from the group consisting of free N-acetyl-neuraminic acid (“NANA”), sialic acid-containing oligosaccharides, sialic acid-containing glycoproteins, and gangliosides.

18. The synthetic infant milk formula of claim 1 wherein said sialic acids are comprised of about 200 to 1800 mg/L of sialic acids bound to oligosacchardides.

19. The synthetic infant milk formula of claim 1 wherein said formula comprises about 100 to 550 mg/L of sialic acids bound to glycoproteins.

20. The synthetic infant milk formula of claim 1 wherein said formula comprises about 500 to 600 mg/L sialic acid.

21. The synthetic infant milk formula of claim 20 wherein between about 50 to 100% of said sialic acid is in the form of sialic acid bound to oligosaccharides.

22. The synthetic infant milk formula of claim 21 wherein said oligosaccharides include sialyllactose.

23. The synthetic infant milk formula of claim 1 wherein said sialic acid is exclusive derived from NANA.

24. The synthetic infant milk formula of claim 1 wherein said cholesterol is in the form of a cholesterol precursor selected from the group consisting of squalene, lanosterol, dimethylsterol, methostenol, lathosterol, and desmosterol.

25. The synthetic infant milk formula of claim 1 wherein said formula further comprises vitamins and minerals.

26. The synthetic infant milk formula of claim 1 wherein said formula is delivered parenterally.

27. The synthetic infant milk formula of claim 1 wherein said formula comprises about 10-35 g/L protein, about 20-50 g/L lipid, and about 60-110 gm/L of carbohydrate.

28. The synthetic infant milk formula of claim 1 where said LC-PUFAs comprise about 0.3 to 1.2 wt % and about 0.05 to about 2.87 wt % DHA of total fatty acids and about 400 to 700 mg/L of sialic acid, and about 15 to 26 mg/dL cholesterol.

29. A method of enhanced neurological development in an infant comprising administering the synthetic infant formula of claim 1 to said infant.

30. A method of enhancing the gastrointestinal protection of an infant comprising administering the synthetic infant formula of claim 1 to said infant.

31. A method of enhancing the immune function in an infant comprising administering the synthetic infant formula of claim 1 to said infant.
